(19) United States
(12) Patent Application Publication
(10) Pub. No.: US 2014/0209602 A1
(43) Pub. Date: Jul. 31, 2014

(54) FLEXIBLE PLASTIC PACKAGING BOX

(71) Applicant: NEW HIP LIK PACKAGING PRODUCTS (SHENZHEN) CO., LTD., Shenzhen, Guangdong (CN)

(72) Inventor: Jingmin Yang, Shenzhen Guangdong (CN)

(21) Appl. No.: 13/979,831

(22) PCT Filed: Mar. 1, 2013
(86) PCT No.: PCT/CN2013/072040

§ 371 Date: Feb. 6, 2014

(30) Foreign Application Priority Data
Jan. 28, 2013 (CN) 201320047287.4

(51) Int. Cl. B65D 41/10; B29D 22/00

(52) U.S. Cl. CPC B65D 41/10; B29D 22/003
USPC 220/213; 264/250

(57) ABSTRACT

A flexible plastic packaging box includes a lid and a box body having an opening at one end. The lid includes a lid body and an annular ring surrounding a periphery of the lid body. The box body is provided with an outer flange at a rim thereof adjacent to the opening surrounding an outer wall of the box body. The annular ring may be engaged with the outer flange such that the lid is detachably attached to the box body and seals the opening of the box body. The annular ring surrounding the periphery of the lid body forms a latching groove surrounding the lid body, the annular ring is capable of engaging the outer flange, and because of the elasticity of the flexible plastic, the lid is more reliably fixed on the box body and seals the opening of the box body.

### CROSS-REFERENCE TO RELATED APPLICATIONS

This application is a U.S. National Phase application submitted under 35 U.S.C. §371 of Patent Cooperation Treaty application serial no. PCT/CN2013/072040, filed Mar. 1, 2013, and entitled FLEXIBLE PLASTIC PACKAGING BOX, which application claims priority to Chinese patent application serial no. 201320047287.4, filed Jan. 28, 2013, and entitled [symbol] .

Patent Cooperation Treaty application serial no. PCT/CN2013/072040, and Chinese patent application serial no. 201320047287.4, are incorporated herein by reference.

### TECHNICAL FIELD

The present invention relates to packing containers, and more particularly relates to a flexible plastic packaging box.

### BACKGROUND

The flexible plastic packaging box is usually used for packing smaller products, such as candies, chocolate, cosmetics and the like. The flexible plastic packaging box usually includes a box body and a lid, when the product is loaded in the inside of the box body, the box body is covered by the lid, and then tape is used to stick the box body and the lid such that the lid is fixed to the box body and seals an opening end of the box body. However, the lid is not firmly fixed to the box body in this way, which will result in the sliding of the products and cause the damage to the commodities during the transportation.

### SUMMARY

One object of the present invention is to provide a flexible plastic packaging box which a lid thereof is firmly fixed to a box body thereof.

A flexible plastic packaging box, includes: a lid, and a box body having an opening at one end thereof; the lid includes a lid body and an annular ring surrounding a periphery of the lid body, the box body is provided with an outer flange at a rim thereof adjacent to the opening surrounding an outer wall of the box body, the annular ring is engaged the outer flange such that the lid is detachably attached to the box body and seals the opening of the box body.

In one embodiment, the box body is integrally formed with the outer flange, the outer flange is formed by extending the rim of the box body and rolling to an arc shape.

In one embodiment, the lid includes an arc-shaped convex edge convexly positioning on the lid body and surrounding the lid body, the annular ring is connected to the arc-shaped convex edge.

In one embodiment, the lid body is integrally formed with the arc-shaped convex edge.

In one embodiment, the lid body is provided with a protrusion at a middle portion thereof protruding from inside towards outside of the box body.

In one embodiment, the box body is frustum-shaped or cylindrical.

In one embodiment, the box body includes a round bottom and a tube having two openings at both ends, the tube is cylindrical or frustum-shaped, one end of the tube is connected to a periphery of the bottom, the other end of the tube forms the opening of the box body.

In one embodiment, the tube is provided with a reinforcement ring at one end thereof surrounding one opening, the reinforcement ring is connected to the periphery of the bottom.

In one embodiment, the opening end of the frustum-shaped box body has an area greater than an area of the round bottom.

In one embodiment, the box body has a wall thickness of 0.15 mm to 0.5 mm, the lid has a thickness of 0.15 mm to 0.5 mm.

The annular ring of the lid of the flexible plastic packaging box surrounding a periphery of the lid body forms a latching groove surrounding the lid body. Thus, the annular ring is capable of engaging the outer flange, in addition, because of the elasticity of the flexible plastic material, the lid is more reliably fixed to the box body and seals the opening end of the box body.

### BRIEF DESCRIPTION OF THE DRAWINGS

FIG. 1 is a schematic, cross-sectional view of an embodiment of a flexible plastic packaging box; and

FIG. 2 is a schematic, cross-sectional view of another embodiment of a flexible plastic packaging box.

### DETAILED DESCRIPTION

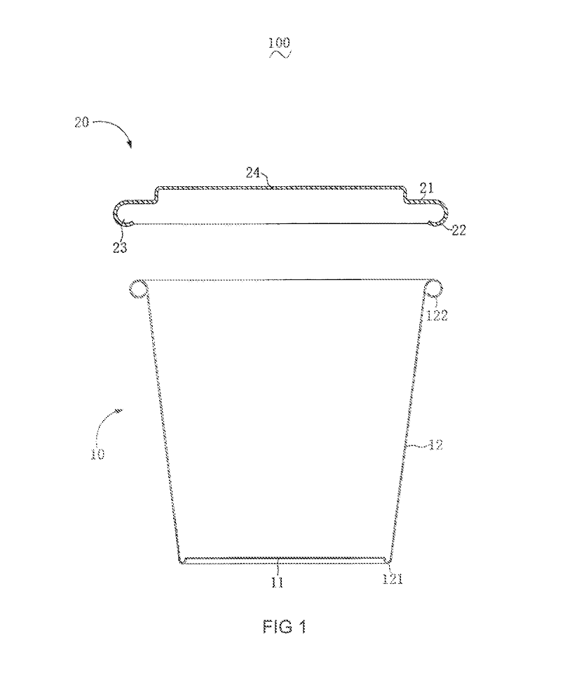

Referring to FIG. 1, an embodiment of a flexible plastic packaging box 100 includes a box body 10 and a lid 20.

The box body 10 has an end defining an opening. The box body 10 includes a round bottom 11 and a tube 12 having two openings at both ends, one end of the tube 12 is connected to a periphery of the bottom 11, the other end of the tube 12 forms the opening of the box body 10. The bottom 11 has a thickness of 0.15 mm to 0.5 mm.

The tube 12 is a frustum-shaped tube having two openings at both ends thereof. One end with smaller area of the tube 12 is connected to the periphery of the bottom 11, such that the cylindrical-shaped box body 10 having an opening is formed, and the opening of the tube 12 has a larger area, therefore it is convenient to load or remove the product. It is to be understood that, in alternative embodiments, the tube 12 may be a cylindrical tube having two openings at both ends, one end of the tube 12 is connected to the periphery of the bottom 11, such that the box body 10 having an opening is formed.

The tube 12 is made of plastic sheet which has a thickness of 0.15 mm to 0.5 mm, it can, on the one hand, facilitate the processing of molding, on the other hand, determine a wall thickness of the tube 12 to be 0.15 mm to 0.5 mm, which ensures that the flexible plastic packaging box 100 has a sufficient strength.

The end of the tube 12 connecting to the bottom 11 forms a reinforcement ring 121. The reinforcement ring 121 is formed by curling a periphery of the end with smaller area of the tube 12 to an arc circle, which surrounds the end of the tube 12. The periphery of the bottom 11 is fixed to the reinforcement ring 121 via an adhesive or a high frequency bonding.

The reinforcement ring 121 is formed at the end having smaller area of the tube, which on the one hand facilitates the connecting to the bottom 11, on the other hand it can enhance the strength of the bottom of the box body 10.

The box body 10 is provided with an outer flange 122 at a rim thereof adjacent to the opening surrounding an outer wall of the box body 10, the outer flange 122 surrounds an outer wall of the tube 12. In the illustrated embodiment, the outer flange 122 is formed by extending and rolling the rim of the box body 10 to an arc shape. The outer flange 122 and the tube 12 are integrally formed. In alternative embodiments, the outer flange 122 can be bonded to the outer wall of the tube 12 by adhesives.

The lid 20 includes a lid body 21 and an annular ring 22 surrounding the periphery of the lid body 21. The annular ring 22 defines a latching groove 23 surrounding the periphery of the lid body 21.

Preferably, the lid 20 includes a protrusion 24 positioned at a middle portion of the lid body 21, the protrusion 24 protrudes from inside towards outside of the box body 10. The shape of the protrusion 24 may be round. The protrusion 24 can, on the one hand, enhance the strength of the lid 20, on the other hand, improve the appearance of the flexible plastic packaging box 100. The lid 20 may be integrally formed by a blister process.

When using the flexible plastic packaging box 100, since the annular ring 22 defines the latching groove 23 surrounding the periphery of the lid body 21, the annular ring 22 is capable of engaging the outer flange 122. In addition, because of the elasticity of the flexible plastic material, the lid 20 is more reliably fixed on the box body 10 and seals the opening end of the box body 10.

The box body 10 with such shape can be tightly engaged with the lid 20, and the lid 20 is more reliably fixed to the box body 10. During the transportation, the product are not likely to slide out of the packaging box, thus it can be a good protection for the product. In addition, it is not necessary to use the tape after the flexible plastic packaging box 100 is employed, and the tape bonding process can be also omitted, thus the cost is reduction. Furthermore, the lid 20 is detachably fixed to the box body 10, which can be used to repeatedly seal, and it is convenient to storage.

The flexible plastic packaging box 100 may be made of polyvinyl chloride (PVC), polyethylene terephthalate (PET) or polypropylene (PP).

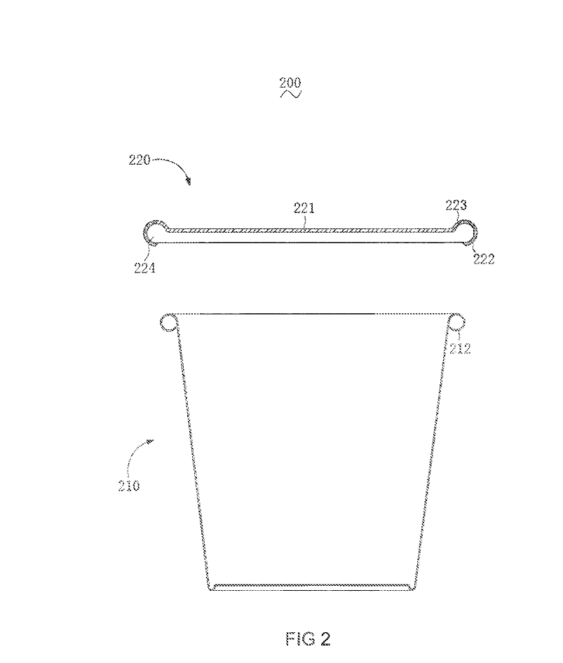

Referring to FIG. 2, another embodiment of a flexible plastic packaging box 200 includes a box body 210 and a lid 220.

The structure of the box body 210 is identical to that of the box body 10, the shape of the box body 210 is also cylindrical or frustum-shaped. The opening of the box body 210 defines an outer flange 212 surrounding the opening.

The lid 220 includes a round lid body 221 and an annular ring 222. The periphery of the lid body 221 defines an arc-shaped convex edge 223, the annular ring 222 is connected to the arc-shaped convex edge 223 and surrounds the periphery of the lid body 221, such that the annular ring 222 defines a latching groove 224 surrounding the periphery of the lid body 221

The lid body 221 and the arc-shaped convex edge 223 are integrally formed, they are made of round flexible plastic material by pressing. The annular ring 222 is fixed to the periphery of the arc-shaped convex edge 223 via a high frequency bonding. Patterns can be printed on the flexible plastic material before the machine shaping, the processing will not have any tensile effects on the patterns, so the patterns formed on the flexible plastic packaging box is permanent, beautiful and practical.

The flexible plastic packaging box 200 may be made of polyvinyl chloride (PVC), polyethylene terephthalate (PET) or polypropylene (PP).

The outer flange 212 of the box body 210 and the lid 220 of the flexible plastic packaging box 200 are closely attached by the annular ring 222, so the lid 220 is detachably fixed to the box body 210 and seals the opening end of the box body 210. Because the lid 220 is firmly fixed to the box body 210, during the transportation, the product are not likely to slide out of the packaging box, which can be a good protection for the product.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

1. A flexible plastic packaging box, comprising:
a lid, and
a box body having an opening at one end thereof;
wherein the lid comprises a lid body and an annular ring surrounding a periphery of the lid body, the box body is provided with an outer flange at a rim thereof adjacent to the opening surrounding an outer wall of the box body, the annular ring is engaged with the outer flange such that the lid is detachably attached to the box body and seals the opening of the box body.

2. The flexible plastic packaging box according to claim 1, wherein the box body is integrally formed with the outer flange, the outer flange is formed by extending the rim of the box body and rolling to an arc shape.

3. The flexible plastic packaging box according to claim 1, wherein the lid comprises an arc-shaped convex edge convexly positioning on the lid body and surrounding the lid body, the annular ring is connected to the arc-shaped convex edge.

4. The flexible plastic packaging box according to claim 3, wherein the lid body is integrally formed with the arc-shaped convex edge.

5. The flexible plastic packaging box according to claim 1, wherein the lid body is provided with a protrusion at a middle portion thereof protruding from inside towards outside of the box body.

6. The flexible plastic packaging box according to claim 1, wherein the box body is frustum-shaped or cylindrical.

7. The flexible plastic packaging box according to claim 6, wherein the box body comprises a round bottom and a tube having two openings at both ends, the tube is cylindrical or frustum-shaped, one end of the tube is connected to a periphery of the bottom, the other end of the tube forms the opening of the box body.

8. The flexible plastic packaging box according to claim 7, wherein the tube is provided with a reinforcement ring at one end thereof surrounding one opening, the reinforcement ring is connected to the periphery of the bottom.

9. The flexible plastic packaging box according to claim 7, wherein the opening of the frustum-shaped box body has an area greater than an area of the round bottom.

10. The flexible plastic packaging box according to claim 1, wherein the box body has a wall thickness of 0.15 mm to 0.5 mm, the lid has a thickness of 0.15 mm to 0.5 mm.

11. A method of producing a flexible plastic packaging box, the method comprising the following steps:
forming a lid, including a lid body and an annular ring;
the lid body having a periphery;
the annular ring surrounding the periphery of the lid body and defining a latching groove surrounding the periphery of the lid body; and
forming a box body including a tube having two openings and a round bottom having a periphery;
the opening at one end of the tube being connected to the periphery of the bottom, and the opening at the other end of the tube having a rim surrounded by an outer flange;
the outer flange being detachably engageable by the latching groove of the annular ring such that the lid is detachably attached to the box body and seals the opening of the box body;
wherein at least one of the lid body or the round bottom is formed separately from the respective annular ring or tube and fixed to the respective annular ring or tube after forming.

12. The method of producing a flexible plastic packaging box according to claim 11, wherein the round bottom is formed separately from the tube and the periphery of the bottom is fixed to the tube via an adhesive or high frequency bonding.

13. The method of producing a flexible plastic packaging box according to claim 12, further comprising the step of forming a reinforcement ring on the end of the tube to be connected to the bottom by curing a periphery of the end to an arc circle prior to fixing the round bottom to the tube.

14. The method of producing a flexible plastic packaging box according to claim 11, wherein the lid body is formed separately from the annular ring and the periphery of the lid body is fixed to the annular ring via high frequency bonding.

15. The method of producing a flexible plastic packaging box according to claim 14, further comprising the step of pressing a round flexible plastic material to integrally form the lid body and an arc-shaped convex edge on the lid body prior to fixing the lid body to the annular ring.

16. The method of producing a flexible plastic packaging box according to claim 15, further comprising the step of printing a pattern on the flexible plastic material before machine shaping.

17. A flexible plastic packaging box, comprising:
a lid body and an annular ring;
the lid body having a periphery;
the annular ring surrounding the periphery of the lid body and defining a latching groove surrounding the periphery of the lid body; and
a box body including a tube having two openings and a round bottom having a periphery;
the opening at one end of the tube being connected to the periphery of the bottom, and the opening at the other end of the tube having a rim surrounded by an outer flange;
the outer flange being detachably engageable by the latching groove of the annular ring such that the lid is detachably attached to the box body and seals the opening of the box body.

18. The flexible plastic packaging box according to claim 17, wherein the tube further comprises a reinforcement ring disposed at one end of the tube surrounding one opening.

19. The flexible plastic packaging box according to claim 18, wherein the periphery of the bottom is connected to the reinforcement ring.

20. The flexible plastic packaging box according to claim 19, wherein the outer flange extends from the rim and has an arc shape.
